(19) United States
(12) Patent Application Publication
(10) Pub. No.: US 2006/0117629 A1
(43) Pub. Date: Jun. 8, 2006

(54) Reusable decorative display for foliage and decorative items

(76) Inventor: Amy Errington, Cedar Rapids, IA (US)

Correspondence Address: ALLAN L HARMS, 2750 FIRST AVENUE NE, SUITE 420, CEDAR RAPIDS, IA, 52402, US

(21) Appl. No.: 11/007,396

(22) Filed: Dec. 8, 2004

(51) Int. Cl. G09F 3/20

(52) U.S. Cl. 40/658

(57) ABSTRACT

A wreath or other decorative display which allows for attachment and removal of decorative items on the base of the display. Attached to the base are grasping clips which retain decorative items in their jaws such that the decorative items may be removed or changed when desired. The grasping clips may be attached to the base by fixed or articulable mountings or they may be selectively detachable from the base.

### BACKGROUND

The present invention pertains to decorative displays such as wreaths, tabletop floral displays, garlands and the like, and particularly to decorative displays to which foliage, ornaments, pine cones, ribbons, fruit or fruit imitations, and flowers may be attached.

Traditionally, holiday wreaths and decorations featuring natural or artificial foliage and plant matter have been attached to bases constructed in toroidal shapes, hemispherical shapes and other geometric shapes. The bases are customarily formed of wire or narrow bands of metal or plastic which are joined at intersections of the wire or bands to form a rigid gridwork. Then foliage and decorative elements are attached to the gridwork with floral wire or with adhesives. Changes to the decorative displays are difficult if not impossible to make when wire or adhesives have been used to attach decorative elements. The elements will likely be damaged or degraded by removal efforts and therefore the elements will not be usable in other decorative displays. Furthermore, the removal of decorative elements attached by adhesives may render the base unusable for future use.

In the case of fresh floral arrangements, replacement or removal of a wilted or damaged floral item cannot easily be undertaken when such items are wired to the gridwork or fastened with adhesives.

The patent to DiMuzio, U.S. Pat. No. 6,237,882 teaches a decorative display unit with removable mounting spikes to skewer fruits and vegetables for fastening them to the display frame. This display limits the decorative items which can be secured to items which can be pierced with a spike to hold it. In an alternative embodiment, DiMuzio teaches that cup elements can be retained to the frame to receive stems of cut flowers.

A decorative wreath or other display structure which permits desired changes and revisions to the arrangement of the decorative items attached to it would be beneficial to children who wish to pursue decorative design and for amateur florists to experiment with floral arrangements. It would also be desirable to have a frame which can be reused repetitively.

### SUMMARY OF THE INVENTION

The present invention provides a wreath or other decorative display which allows for attachment and removal of decorative items on the gridwork base of the display. The gridwork may be constructed of wires or bands or a mixture thereof fixed together at the intersections of the wires or bands. Alternatively, the base may present a generally solid surface, particularly one covered with hook and loop fasteners. Attached to the gridwork are grasping clips which may be spring clips such as are commonly known as “alligator clips” or they may be other sorts of grasping devices which are capable of retaining decorative items in their jaws such that the retained items may be removed when desired. The grasping clips may be welded to the gridwork directly, or they may be retained to the gridwork by other structures such as with magnets, hook and loop fasteners, rivets, adhesives, by ball and socket hinges or other articulable mountings. The clips may be carried on malleable wires and they may also be detachably secured to the gridwork by use of other clips which engage the bands or wires. The clips may be adjustable in orientation on the gridwork unless welded or riveted to the gridwork. Of course, bending of the segments of the gridwork may be accomplished to reposition a permanently fastened grasping clip.

It is an object of the invention to provide a decorative display such as a wreath or tabletop display which can be modified by addition or removal of decorative items as desired. It is also an object of the invention to provide a decorative display which requires no use of adhesives or attachment wire or cords to attach decorative items to the underlying base of the display. It is further an object to provide a decorative display which may be reused through removal of existing decorative items and replacement with other decorative items. It is yet another object of the invention to provide a wreath or other decorative display which permits the removal of wilted or other deteriorated decorative items or foliage and replacement of it with fresh or new decorative items. It is yet an additional object of the invention to provide a decorative display for use by children or amateur florists who may experiment with the composition and arrangement of decorative items detachably fixed to the base of the display.

These and other salutary objects of the invention will become understood from the detailed description of the invention which follows.

### DESCRIPTION OF THE DRAWING FIGURES

FIG. 1 is a perspective of a decorative display in a wreath shape characterized by the present invention.

FIG. 2 is an enlarged exploded perspective of a ball and socket attachment of a grasping element of the invention mounted to a segment of a display frame.

FIG. 3 is an enlarged perspective of a grasping element provided with one part of a hook and loop fastener which may be mated with complementary hook and loop fasteners attached to a display frame.

FIG. 4 is an enlarged perspective of a grasping element mounted by welding to a display frame.

FIG. 5 is an enlarged perspective of a compound grasping clip adapted for use with the invention.

FIG. 6 is an enlarged perspective of a grasping element provided with a magnet to retain it to a metal frame of a decorative display according to the present invention.

FIG. 7 is a perspective view an alternative decorative display provided with grasping elements attached to the display frame by alternate attaching modes.

FIG. 8 is a front elevation of a second alternate embodiment of the invention provided with grasping elements on malleable stems.

FIG. 9 is an enlarged perspective of an alternative grasping element provided with a clasp to grasp a part of the frame of a decorative display.

FIG. 10 is an enlarged perspective of a resilient grasping clip provided with a socket to receive a ball attached to a segment of a frame.

### DETAILED DESCRIPTION OF THE INVENTION

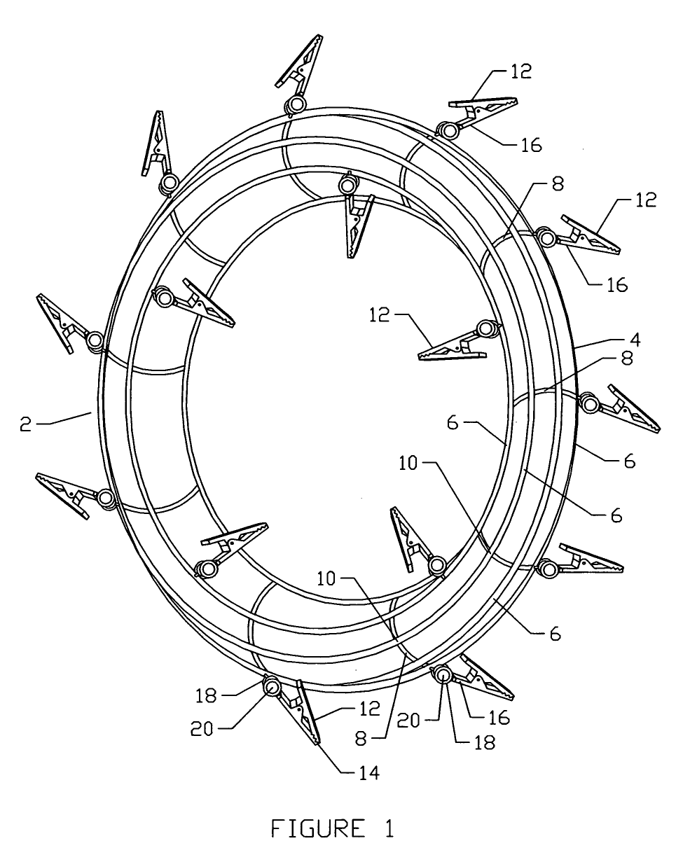

Now referring to the drawings and particularly to FIG. 1, a preferred embodiment of the invention 2 is illustrated. Invention 2 comprises a base 4 which in the embodiment of FIG. 1 is a toroid constructed of plural circular wires 6 which may be bands or other elongate narrow or slender members, which are joined to and held rigid by transverse curvilinear wire segments 8 which are joined to the circular wires 6 at intersections 10.

Secured to base 4 spaced are grasping elements 12 which may be spaced equidistantly or at irregular spacings. Each grasping element 12 may be a spring clip having a mouth 14. Fixed to handle 16 of each grasping element 12 is a socket member 18 which receives a ball 20 which is fixed to the base 4.

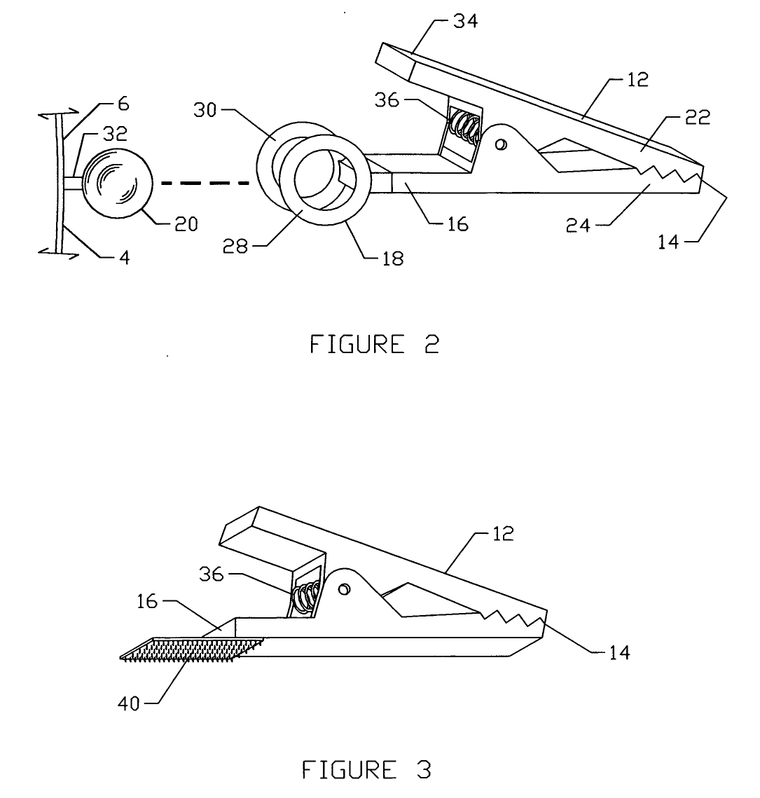

Referring to FIG. 2, an enlarged view of the first preferred embodiment grasping element 12 and its selectively positionable attachment to base 4 is illustrated. Ball 20 is fixed to wire 6 of base 4 (only a short segment is shown) by post 32. Grasping element 12 comprises first jaw member 22 and second jaw member 24 which cooperate to provide mouth 14 which may grasp a ribbon, elements of foliage, flowers, fruit items, pine cones, berries, branches, sprigs or other items desired to be retained to the base 4. Jaw members 22, 24 are urged into abutment by spring element 36. When a decorative item is to be grasped by grasping element 12, lever 34 is urged toward handle 16 against the bias of spring 36 such that jaws 22 and 24 may be separated.

Opposing mouth 14 is handle 16 to which may be fixed a socket member 18 which may comprise spaced apart rings 28, 30. Rings 28, 30 may capture ball 20 between them thereby allowing grasping element 12 to restrictedly rotate about ball 20 and still be retained to wire 6. The stiffness of rings 28, 30 and their spacing will frictionally resist movement of grasping element 12 about ball 20. Therefore each grasping element 12 is articulable on base 4 but will remain positioned as desired until sufficient force is applied to reposition it.

FIG. 3 illustrates a grasping element 12 provided with a hook and loop fastener element 40, which may be selectively joined to a complementary hook and loop fastener fixed to base 4. Hook and loop fastener 40 may be adhered to handle 16. The mating part of the hook and loop fastener combination may be fixed by adhesive or other permanent attachment to the gridwork of base 4 to be detachably joined to hook and loop fastener element 40.

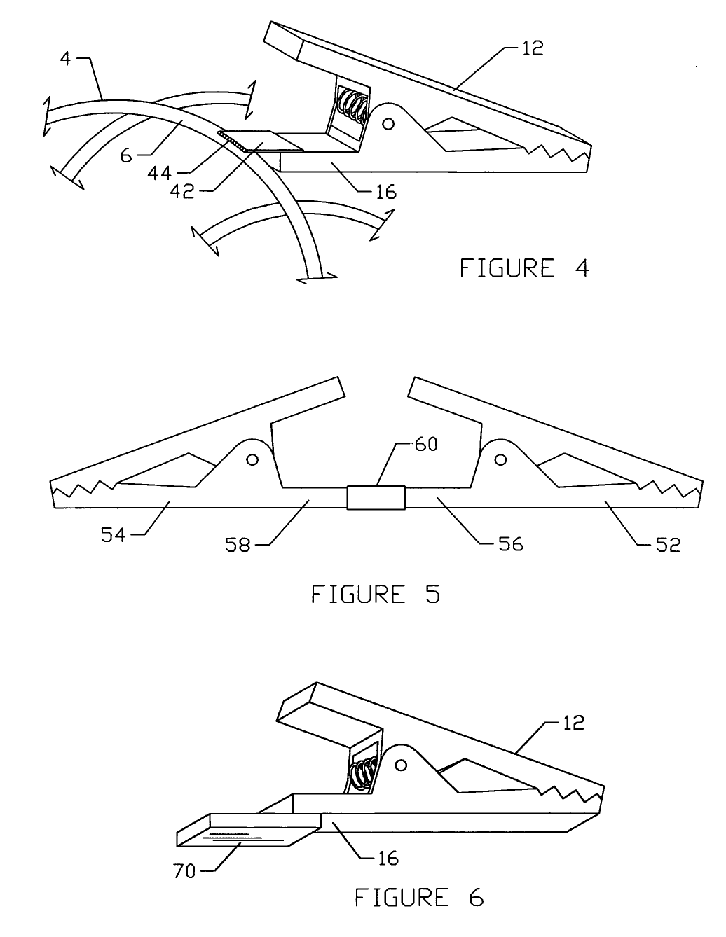

Referring next to FIG. 4, another grasping element 12 is shown fixed by welding to one of wires 6 of base 4. Welding tab 42 is permanently joined to handle 16 of grasping element 12 and is welded to wire 6 at weld 44. Welding tab 42 may be stiff or it may be malleable in which latter case, grasping element 12 may be selectively oriented relative to wire 6 as desired.

FIG. 5 discloses a compound grasping clip 50. A first spring clip 52 is joined at handle 56 thereof to the handle 58 of second spring clip 54 by sleeve 60 which may be welded or adhesively joined to handle 56, 68. One of spring clips 52, 54 may be used to grasp wire 6 or wire segment 8 of base 4 in the jaws thereof while the other of spring clips 52, 54 may be used to grasp a decorative element desired to be retained to base 4.

FIG. 6 illustrates a grasping element 12 to which a magnet 70 is retained by magnetic attraction if handle 16 of grasping element 12 is ferromagnetic, or magnet 70 may alternatively be fixed to handle 16 by adhesive or other mechanical fixing means.

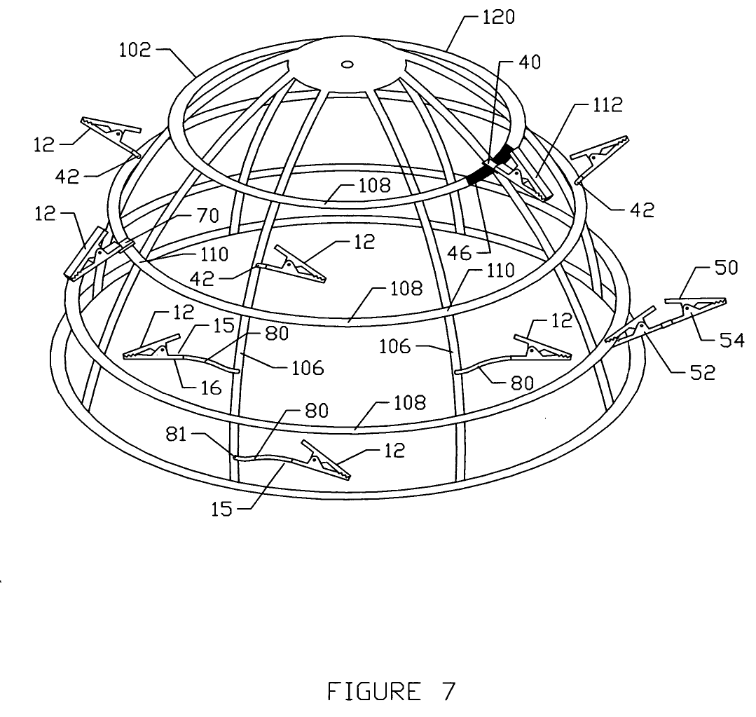

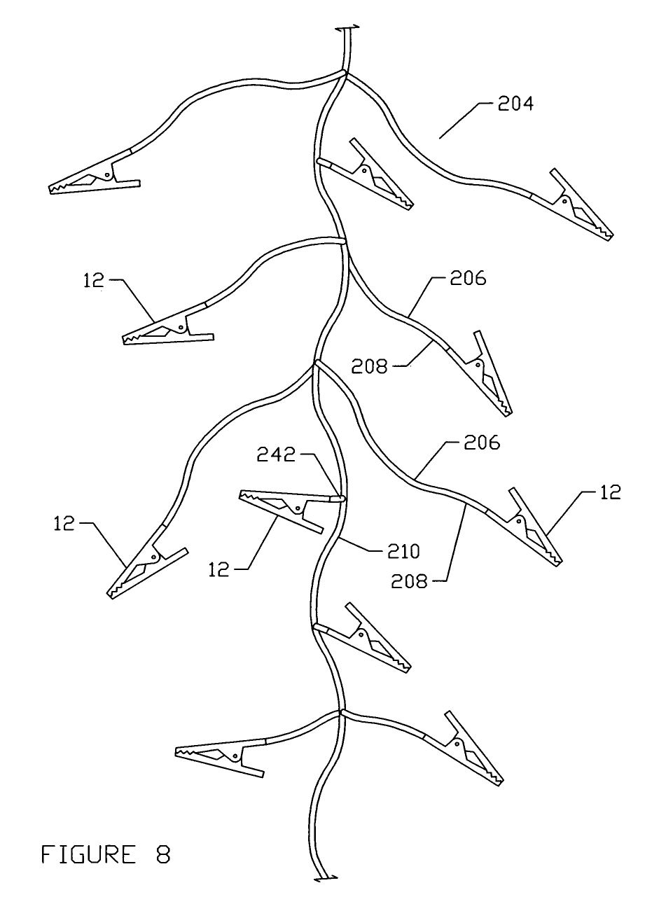

Referring now to FIG. 7, a generally hemispherical decorative display 102 is shown. Display 102 comprises an open gridwork 120 of latitudinal bands 108 and longitudinal bands 106 which are joined at intersections 110 thereof to form a generally rigid gridwork 120. FIG. 7 illustrates that an assortment of differing attachment structures for grasping elements 12 may be used with the same display 102. Each stemmed grasping element 15 includes a grasping element 12 fixed at the handle 16 thereof to a stem 80 which is fixed at its opposing end 81 by welding or adhesive to one of bands 106, 108. Stems 80 may be elongate or relatively short in length. Stems 80 may be polymeric but preferably are of a malleable metal so that a grasping element 12 fixed to an end of a stem 80 may be moved into a desired position and will remain there until repositioned by a user.

Other of grasping elements 12 are shown joined to one of bands 106, 108 by a welding tab 42. Another of grasping elements 12 is retained to one of latitudinal bands 108 by magnet 70. It should be understood that if gridwork 120 is ferromagnetic, that magnet equipped grasping elements 12 may be located along bands 106, 108 wherever desired.

A hook and loop equipped grasping element 112 is shown retained to one of latitudinal bands 108 by a strip 46 of hook and loop fastener which interlocks with hook and loop fastener element 40 mounted on hook and loop equipped grasping element 112. It is to be understood that hook and loop equipped grasping element 112 may be moved to any location along strip 46 and that strip 46 may be of any length and may be chosen to extend the entirety of gridwork 120. Hook and loop equipped grasping element 112 with hook and loop fastener element 40 may be positioned in several orientations so long as hook and loop fastener element 40 is in contact with strip 46.

Also retained to gridwork 120 is compound grasping clip 50, with a first spring clip 52 thereof grasping a part of a latitudinal band 108. The second spring clip 54 is available to retain a decorative item in the jaws thereof.

Referring now to FIG. 8, a network base 204 is disclosed. Network base 204 resembles structure of a tree or bush comprising multiple branches 206 and is provided with plural grasping elements 12, some of which are joined to free ends 208 of branches 206 while others are joined to main stem 210 at connecting strips 242. Branches 206 and main stem 210 may be constructed of malleable materials or they may be resilient or flexible. In any case, grasping elements 12 are available to retain ornamental balls, fruits, pine cones, holly, roping, or any other decorative item desired to be removably attached to network base 204.

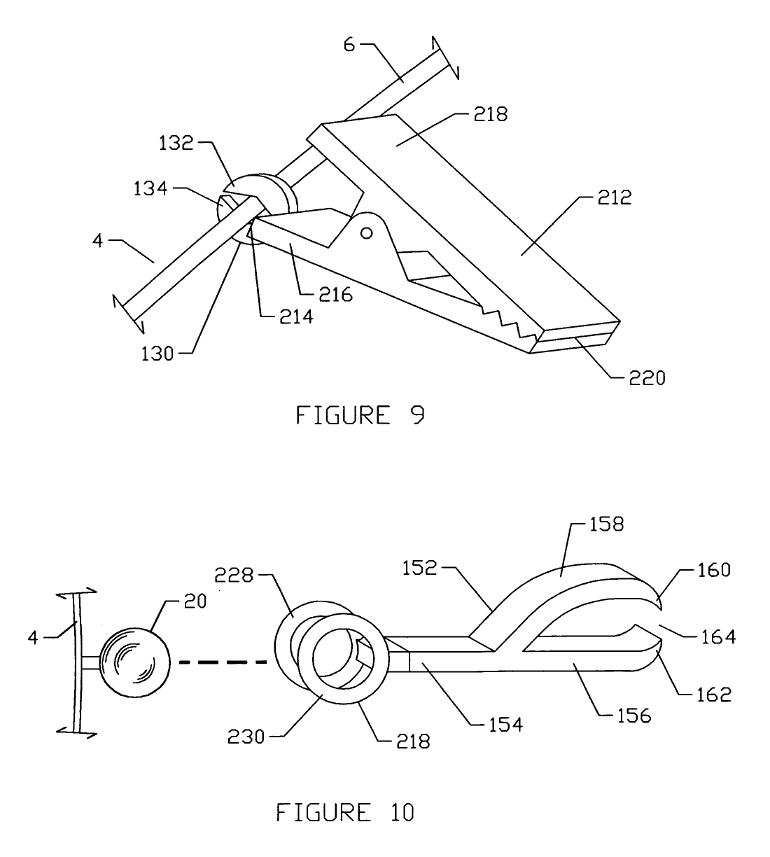

FIG. 9 discloses yet another mounting structure for retention of an alternative embodiment grasping element or clamp 512. Clamp 212 comprises handle 216 and opposing lever 218 which can be urged toward each other to open mouth 220. Clamp 212 may be of a larger size than grasping elements 12 shown in FIGS. 1-2 in order to grasp larger decorative items. Clamp 212 is provided at its handle end 214 with attached clasp 130 which includes resilient opposing curvilinear retainers 132, 134 which may be forcibly slid onto a wire 6 (of e.g., base 4 as in FIG. 1) to retain clamp 212 to wire 6. It is to be understood that clamp 212 may be rotated about wire 6 while clasp 130 substantially surrounds wire 6.

Referring now to FIG. 10, a tong 152 is illustrated. Tong 152 may be constructed of resilient material such as spring steel or formed plastic. Tong 152 comprises a handle 154 to which are mounted spaced apart rings 228, 230 which serve as a socket 218 to receive and retain ball 20 fixed to base 4. Tong 152 also comprises first and second jaw members 156, 158 which have opposing free ends 162, 160 respectively which are separated by a small gap 164 when at rest. A decorative element may be received through gap 164 and retained between by jaw members of tong 152, which is retained by socket 218 to ball 20 of base 4 and is articulable thereabout.

Although the present invention has been described with reference to preferred embodiments, workers skilled in the art will recognize that changes may be made in form and detail without departing from the spirit and scope of the invention.

Having described the invention,

I claim:

1. A decorative display comprising
a base frame,
at least one grasping member retained to the base frame,
the grasping member including jaws to selectively retain a decorative item to the base frame.

2. The decorative display of claim 1 wherein
the at least one grasping member is a spring clip.

3. The decorative display of claim 1 wherein
the base frame comprises ferromagnetic material,
the at least one grasping member is selectively retained to the base frame by a permanent magnet.

4. The decorative display of claim 1 wherein
the at least one grasping member is welded to the base frame.

5. The decorative display of claim 1 wherein
the at least one grasping member comprises an elongate malleable wire retained at a first end thereof to the grasping member,
the malleable wire retained at a second end thereof to the base frame.

6. The decorative display of claim 1 wherein
the at least one grasping member comprises one of a ball and a complementary socket,
the base frame having an other of the ball and complementary socket attached thereto,
whereby the ball is receivable in the complementary socket and the grasping member may be reoriented selectively upon the base frame.

7. The decorative display of claim 1 wherein
the at least one grasping member is retained to the base frame by hook and loop fasteners.

8. The decorative display of claim 1 wherein
the at least one grasping member comprises a jaw end and a handle end,
a second grasping member having jaws and an opposing handle,
the handle of the second grasping member fixed to the handle end of the at least one grasping member,
the jaws of the second grasping member receiving a part of the base frame.

9. The decorative display of claim 1 wherein
the at least one grasping member comprises a jaw end constructed of resilient material,
the jaw end comprises a first jaw element opposing a second jaw element,
the first jaw element separated by a small gap from the second jaw element when the first and second jaw elements are at rest,
whereby the decorative item may be urged into touching engagement with the first and second jaw elements in the gap therebetween.

10. The decorative display of claim 1 wherein
the at least one grasping member includes a handle opposing the jaws thereof,
the at least one grasping member including a second pair of opposing jaws fixed to the handle thereof,
the second pair of jaws constructed of resilient material,
the second pair of jaws releasably grasping the base frame.

11. A decorative display structure to support decorative elements in a selected arrangement comprising
a frame,
at least one grasping member fixed to the frame,
the at least one grasping member multipositionable relative to the frame,
the at least one grasping member securing at least one decorative element.

12. The decorative display structure of claim 11 wherein
the at least one grasping member is articulable upon the frame.

13. The decorative display structure of claim 11 wherein
the at least one grasping member includes an elongate stem element,
the stem element having an end fixed to the frame.

14. The decorative display structure of claim 11 wherein
the at least one grasping member is releasably attached to the frame.

15. The decorative display structure of claim 11 wherein
the frame is provided with at least one of a ball and socket,
the at least one grasping member including an other of a ball and socket,
the ball received in the socket.

16. The decorative display structure of claim 11 wherein
the frame is a gridwork of narrow elongate elements joined at intersections thereof,
a plurality of grasping members mounted to the gridwork,
each of the grasping members articulable upon the gridwork.

17. The decorative display structure of claim 16 wherein
each grasping member releasably secures a decorative element to the gridwork.

18. A decorative display structure comprising
a frame,
plural clip members supported on the frame,
each clip member including opposing paired jaw elements,
a decorative element releasably secured by the jaw elements of the clip members.

19. The decorative display structure of claim 18 wherein
the frame includes balls attached thereto,
each clip member comprising a socket element,
the socket element of each clip member receiving one of the balls attached to the frame,
whereby the clip member is articulable relative to the frame.

20. The decorative display structure of claim 19 wherein
the opposing jaw elements of the clip members are urged into abutment by a spring.
